(19) United States
(12) Patent Application Publication
(10) Pub. No.: US 2017/0252667 A1
(43) Pub. Date: Sep. 7, 2017

(54) DEVICE AND METHOD FOR EVAPORATING WATER FROM AN ABOVE-GROUND STORAGE TANK

(71) Applicant: Rockwater Energy Solutions, Houston, TX (US)

(72) Inventor: Cliff SIMPSON, Ault, CO (US)

(21) Appl. No.: 15/446,247

(22) Filed: Mar. 1, 2017

Related U.S. Application Data
(60) Provisional application No. 62/301,715, filed on Mar. 1, 2016.

(51) Int. Cl. B01B 1/00; C02F 1/04

(52) U.S. Cl. CPC B01B 1/00; C02F 1/043

(57) ABSTRACT

An apparatus may include an evaporation device coupled to a storage tank at least partially filled with a fluid, the evaporation device including a roller in contact with the fluid.

### CROSS-REFERENCE TO RELATED APPLICATIONS

This application is a nonprovisional application that claims priority from U.S. provisional application No. 62/301,715, filed Mar. 1, 2016, which is hereby incorporated by reference in its entirety.

### TECHNICAL FIELD/FIELD OF THE DISCLOSURE

The present disclosure relates to above-ground storage tanks, and specifically to assisted evaporation in above-ground storage tanks.

### BACKGROUND OF THE DISCLOSURE

A storage tank may be used to store fluids. In some cases, an above ground storage tank may be used to store water which is to be evaporated to the surrounding air. Due to the large volume to surface area ratio which may be encountered in a storage tank, evaporation of large quantities of water from the storage tank may progress slowly. Additionally, where a surface layer of a non-volatile fluid is above the water in the storage tank, evaporation of the water may be further inhibited.

### SUMMARY

The disclosure includes an apparatus. The apparatus includes an evaporation device coupled to a storage tank at least partially filled with a fluid, the evaporation device including a roller in contact with the fluid.

The disclosure also includes a method. The method includes providing an evaporation device, the evaporation device coupled to a storage tank at least partially filled with a fluid. The evaporation device includes a roller. The method also includes contacting the fluid with the roller and adhering a portion of the fluid to an outer surface of the roller forming a skin layer. The method additionally includes rotating the roller and evaporating at least part of the skin layer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of an above ground storage tank including an evaporation device consistent with at least one embodiment of the present disclosure.

FIG. 2 depicts a side view of the evaporation device of FIG. 1.

FIG. 3 depicts a cross section view of the evaporation device of FIG. 1.

FIG. 4 depicts a cross section view of the evaporation device of FIG. 1.

FIG. 5 depicts a perspective view of an above ground storage tank including an evaporation device consistent with at least one embodiment of the present disclosure.

FIG. 6 depicts a cross section view of the evaporation device of FIG. 1.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

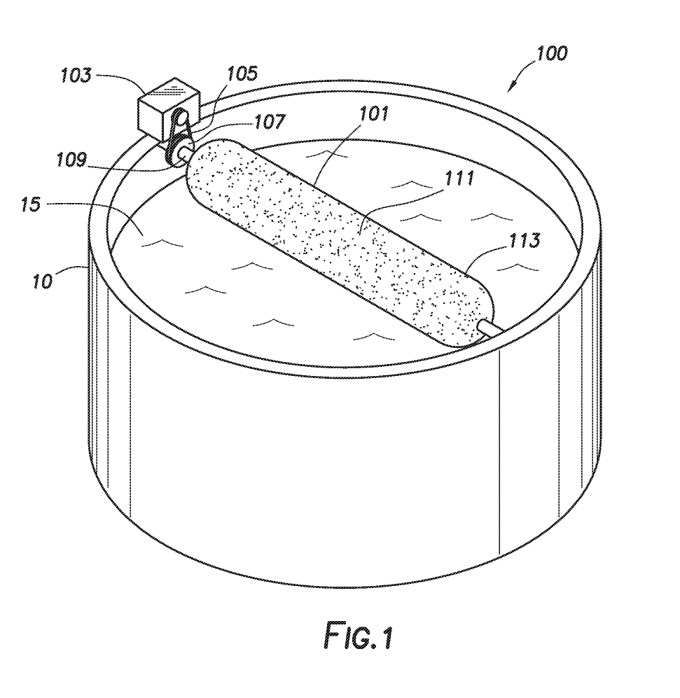

In some embodiments, as depicted in FIG. 1, storage tank 10 may include evaporation device 100. In some embodiments, storage tank 10 may be an above-ground storage tank. Storage tank 10 may be at least partially filled with fluid 15, such as water. In some embodiments, storage tank 10 may include fluids other than water. Although discussed herein with respect to water, one having ordinary skill in the art with the benefit of this disclosure will understand that any fluid having a vapor pressure rendering it capable of evaporation as described herein may be used without deviating from the scope of this disclosure. Additionally, one having ordinary skill in the art with the benefit of this disclosure will understand that as used herein, water is not intended to be limited to pure water, and may include, for example and without limitation, freshwater or brine water. In some embodiments, the fluid surface is substantially free of hydrocarbons or hydrocarbon/water emulsions.

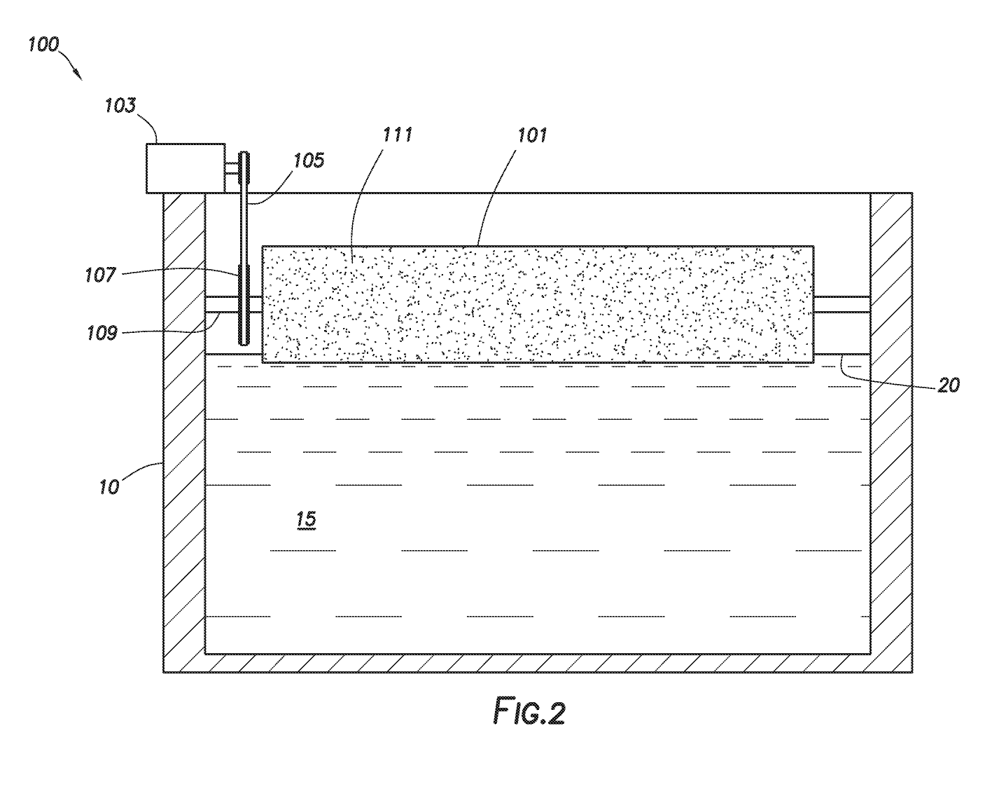

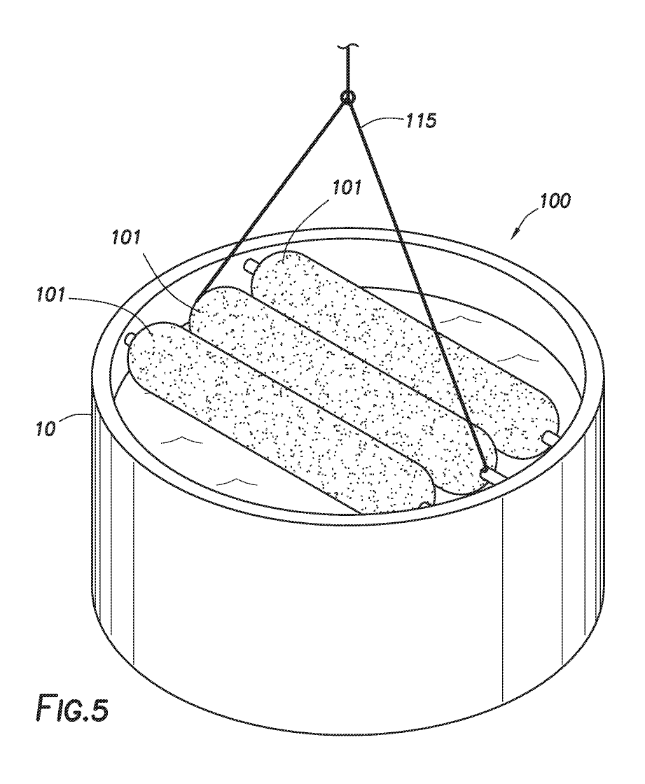

Evaporation device 100 may be mechanically coupled to storage tank 10. Evaporation device 100 may include roller 101. Roller 101 may be a generally cylindrical member. In other embodiments, roller 101 may have a rectangular, pentagonal, hexagonal, octagonal, trictohexacontagonal, or other polygonal cross section. Roller 101 may have an elliptical, oval, or other generally circular cross section. Roller 101 may be positioned at surface 20 of fluid 15 within storage tank 10 as depicted in FIG. 2. Roller 101 may be in contact with or partially submerged in fluid 15. In some embodiments, roller 101 may be rotated by motor 103. In some embodiments, for example and without limitation, motor 103 may be an electric motor, a hydraulic motor or a water driven motor. In some embodiments, motor 103 may be mechanically coupled to roller 101 by one or more power transmission devices 105 including, for example, a transmission, gear, chain, direct drive, or, as depicted in FIG. 2, belt. In some embodiments, the power transmission device 105 may directly rotate roller 101, or, as depicted in FIG. 2, may rotate pulley 107 which may be mechanically coupled to axle 109 which may be mechanically coupled to roller 101. One having ordinary skill in the art with the benefit of this disclosure will understand that other arrangements of motor 103 and power transmission devices may be utilized to rotate roller 101 without deviating from the scope of this disclosure. In some embodiments, roller 101 may be suspended on a cable (115 in FIG. 5), such that it may be raised or lowered, or allowed to be raised or lowered by floating, to account for any changes in height of the surface of fluid 15. Cable 115 may thread roller 101. In some embodiments, cable 115 may partially thread roller 101. In some embodiments, cable 115 may be mechanically coupled to roller 101. In some embodiments, roller 101 may be buoyant such that it floats on the surface of fluid 15.

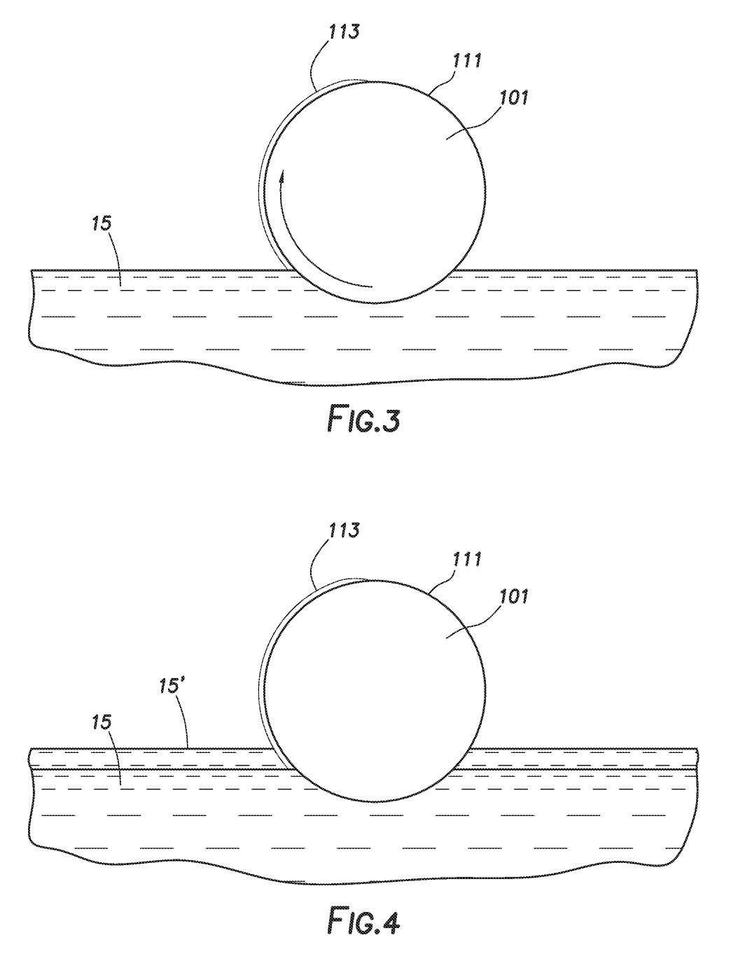

When roller 101 is in contact with fluid 15, a portion of fluid 15 in contact with roller 101 may adhere to outer surface 111 of roller 101 as depicted in FIG. 3, defining skin layer 113. As roller 101 is rotated, skin layer 113 may adhere to roller 101, and be moved into contact with the ambient environment from the body of fluid 15 by the rotation of roller 101. In some embodiments, skin layer 113 may evaporate into the ambient environment. In some embodiments, without being bound to principle and merely for an explanation, by spreading skin layer 113 on outer surface 111 of roller 101, the surface area to volume ratio of skin layer 113 may be higher than that of fluid 15 in storage tank 10, and thus increasing its rate of evaporation. In some embodiments, by rotating roller 101, the rate of evaporation of fluid 15 from storage tank 10 may thus be increased.

In some embodiments, fluid 15 in storage tank 10 may include surface layer 15′ as depicted in FIG. 4. In some embodiments, surface layer 15′ may, for example and without limitation, include oil or an oil/water emulsion which may reduce the rate of evaporation of fluid 15. In some embodiments, roller 101 may be positioned such that it is in contact with fluid 15 below surface layer 15′. In such an embodiment, fluid 15 may adhere to outer surface 111 of roller 101 to form skin layer 113 which may, as roller 101 is rotated, be moved above surface layer 15′, exposing skin layer 113 to the ambient environment.

In some embodiments, the length of roller 101 may be any length up to the width or diameter of storage tank 10. In some embodiments, the diameter of roller 101 may be, for example and without limitation, between 1″ and the length of roller 101. In some embodiments, outer surface 111 of roller 101 may be formed from a material capable of adhesion to fluid 15. In some embodiments, outer surface 111 may be formed from a material capable of wicking fluid 15. In some embodiments, outer surface 111 may be formed from a material to which fluid 15 may adhere. Non-limiting examples of such materials include polypropylene and polyethylene. In some embodiments, the polypropylene or polyethylene may be treated to increase the ability of polypropylene or polyethylene's ability to wick water. In certain embodiments, the material may be reinforced, such as, for example, by scrim.

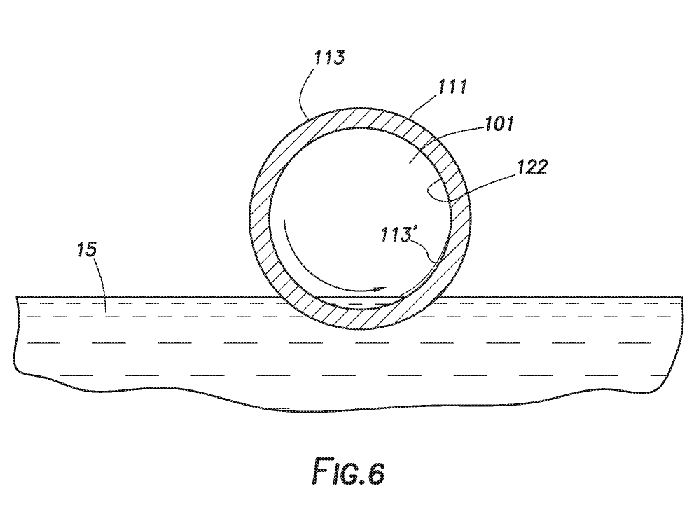

In some embodiments, roller 101 may be hollow. In some embodiments, the interior of roller 101 may be open to allow air to flow therethrough. In such an embodiment, fluid 15 may adhere to inner surface 122 of roller 101 to form second skin layer 113′ which may, as roller 101 is rotated, be moved in the interior of roller 101, exposing second skin layer 113′ to the air flowing through roller 101. In some embodiments, air flowing through the interior of roller 101 may, for example and without limitation, increase evaporation of skin layers 113, 113′ by, without intending to be bound by theory, increasing heat transfer between the ambient environment and evaporation device 100. As shown in FIG. 6, in embodiments where roller 101 is hollow, inner surface 122 of roller 101 may be formed from a material capable of adhesion to fluid 15. In some embodiments, inner surface 122 may be formed from a material capable of wicking fluid 15. In some embodiments, inner surface 122 may be formed from a material to which fluid 15 may adhere. Non-limiting examples of such materials include polypropylene and polyethylene. In some embodiments, the polypropylene or polyethylene may be treated to increase the ability of polypropylene or polyethylene's ability to wick water. In certain embodiments, the material may be reinforced, such as, for example, by scrim.

In operation, with reference to FIG. 1, storage tank 10 may be filled at least partially with fluid 15. Evaporation device 100 may be mechanically coupled to storage tank 10 such that roller 101 is in contact with fluid 15. Roller 101 may be rotated, allowing water in skin layer 113 to evaporate as discussed herein above. As fluid 15 is evaporated, roller 101 may be lowered into storage tank 10 such that roller 101 remains in contact with fluid 15.

In some embodiments, as depicted in FIG. 5, evaporation device 100 may include multiple rollers 101 for a single storage tank 10. As shown in FIG. 5, at least one roller 101 may be suspended on cable 115. In such an embodiment, each roller may be rotated together or individually, in the same direction, or in alternating clockwise and counter-clockwise rotations.

In certain embodiments, roller 101 may be adapted to assist in skimming or otherwise separating hydrocarbons or other fluids from water.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An apparatus comprising:
an evaporation device coupled to a storage tank at least partially filled with a fluid, the evaporation device including a roller in contact with the fluid.

2. The apparatus of claim 1, further comprising a motor, the motor mechanically coupled to the roller.

3. The apparatus of claim 2, wherein the motor is an electric motor, a hydraulic motor, or a water driven motor.

4. The apparatus of claim 2, wherein the motor is mechanically coupled to the roller by a power transmission device including one or more of a belt, chain, direct drive, or gear.

5. The apparatus of claim 1, wherein the roller is hollow.

6. The apparatus of claim 5, wherein the roller has an inner surface, the inner surface comprising a fluid-adherent material.

7. The apparatus of claim 5, wherein the roller has an inner surface, the inner surface comprising a fluid-wicking material

8. The apparatus of claim 1, wherein the roller comprises an outer surface, the outer surface comprising fluid-adherent material.

9. The apparatus of claim 1, wherein the roller comprises an outer surface, the outer surface comprising fluid-wicking material.

10. The apparatus of claim 1, wherein the fluid is water.

11. The apparatus of claim 1, further comprising a cable, the roller being suspended from the cable.

12. A method comprising:
providing an evaporation device, the evaporation device coupled to a storage tank at least partially filled with a fluid, the evaporation device including a roller;
contacting the fluid with the roller;
adhering a portion of the fluid to an outer surface of the roller forming a first skin layer;
rotating the roller; and
evaporating at least part of the first skin layer.

13. The method of claim 12, wherein the evaporation device further comprises a motor and the roller is rotated by the motor.

14. The method of claim 12, wherein the evaporation device further comprises a cable, the roller suspended from the cable, and the method further comprises:
lowering the roller into the storage tank as the fluid is evaporated.

15. The method of claim 12, wherein the roller is hollow and the roller has an inner surface.

16. The method of claim 15 further comprising:
adhering a portion of the fluid to the inner surface of the roller forming a second skin layer; and
evaporating at least part of the second skin layer.
